(19) United States
(12) Patent Application Publication
(10) Pub. No.: US 2026/0294733 A1
(43) Pub. Date: Oct. 1, 2026

(54) VIBRATION MECHANISM OF AN ADULT TOY

(71) Applicant: Dongguan Mise Technology Co., Ltd, Dongguan (CN)

(72) Inventor: Meng Li, Dongguan (CN)

(21) Appl. No.: 19/095,371

(22) Filed: Mar. 31, 2025

(51) Int. Cl. A61H 19/00; A61H 23/02

(52) U.S. Cl. CPC A61H 19/44; A61H 23/0254; A61H 2201/1215; A61H 2201/5023; A61H 2201/5097; A61H 2205/087

(57) ABSTRACT

The present disclosure provides a vibration mechanism for an adult toy, comprising: a housing assembly, a mounting plate, a vibration assembly, an LED light assembly, a battery assembly, a wireless charging assembly and a circuit board. The present invention designs the vibration assembly into different vibration modes, so that users can choose a suitable vibration experience according to personal preferences, thereby enhancing the applicability and personalization of the product; the LED light assembly is used in conjunction with the different vibration modes of the vibration assembly to provide visual feedback; and the wireless charging assembly is used to wirelessly charge the battery assembly, thereby improving the waterproof performance of the vibration mechanism to a certain extent.

### TECHNICAL FIELD

The present disclosure relates to a technical field of sex products, and in particular to a vibration mechanism of an adult toy.

### BACKGROUND

With the development of economy and the progress of society, males are under great pressure at work due to the busy and fast-paced lifestyle. Therefore, relieving the pressure of daily work has become an inevitable need and a social consensus. At the same time, the living standards are constantly improving and the attention to personal health and happiness is increasing. The adult toy market has developed rapidly in recent years. Especially in terms of design and manufacturing technology, this kind of products pay more and more attention to user experience and functionality. As one of the core assemblies of adult toys, the performance of the vibration mechanism directly affects the use effect of the product and the satisfaction of users.

The vibration mechanism of adult toys currently on the market mainly includes the following parts: housing, vibration source (such as drive motor), control circuit and power system. Although these basic assemblies can meet basic functional requirements, there are still some shortcomings in practical applications. Lack of interactive feedback: Existing adult toys often lack effective user feedback mechanisms, such as light prompts, etc., making the user experience relatively monotonous. Poor waterproof performance: Many products do not have good waterproof properties, which limits the occasions and methods of use. Therefore, a vibration mechanism of an adult toy is provided to solve the above problems.

### SUMMARY

The present disclosure provides a vibration mechanism of an adult toy, aiming to overcome the deficiencies of the prior art and propose a vibration mechanism with innovative structure, comprehensive functions and convenient operation, aiming to provide users with a richer, safer and more comfortable use experience.

In order to realize the above purpose, the present disclosure provides the vibration mechanism of an adult toy, comprising: a housing assembly; a mounting plate detachably engaged into the housing assembly; a vibration assembly fixed to the mounting plate, wherein the vibration assembly sequentially drives the mounting plate and the housing assembly to perform a vibration operation; an LED light assembly fixed to the mounting plate, wherein the LED light assembly is configured to emit light in different colors, and the light emitted from the LED light assembly is transmissible through the housing assembly; a battery assembly fixed to the mounting plate; a wireless charging assembly integrated within or on the housing assembly, configured to wirelessly recharge the battery assembly; and a circuit board fixed to the mounting plate, the circuit board being electrically connected to the vibration assembly, the LED light assembly, the wireless charging assembly and the battery assembly.

In one embodiment, the housing assembly comprises a main housing forming a hollow body with an open end; an upper housing fixedly disposed at the open end of the main housing, wherein the upper housing and the main housing are hermetically connected to form an enclosed hollow cavity; and the mounting plate is detachably engaged within the enclosed hollow cavity.

In one embodiment, a light-transmissive housing is disposed on the main housing opposite to the open end, and the light emitted by the LED light assembly is transmitted out of the main housing through the light-transmissive housing.

In one embodiment, the LED light assembly comprises a light board fixed in the positioning groove of the mounting plate and electrically connected to the circuit board; an LED light fixed on the light board can emit lights of different colors, and the light emitted by the LED light is transmitted out of the housing assembly through the light-transmitting housing.

In one embodiment, mounting grooves are symmetrically provided on the inner wall of the main housing; clamping edges are respectively provided on both sides of the mounting plate, and the two clamping edges are respectively detachably snapped into the corresponding mounting grooves.

In one embodiment, a first mounting cavity is provided on the main housing, and the wireless charging assembly is fixed in the first mounting cavity and electrically connected to the circuit board.

In one embodiment, a plurality of anti-slip patterns are provided on the outer sides of both the main housing and the upper housing.

In one embodiment, at least one limiting hole is provided on each of the main housing and the upper housing, and an elastic outer housing is limit-installed on the housing assembly through the limiting holes.

In one embodiment, a second mounting cavity and a third mounting cavity are respectively provided on the mounting plate; the vibration assembly and the battery assembly are respectively fixed within the second mounting cavity and the third mounting cavity.

In one embodiment, the vibration assembly comprises a drive motor disposed in the second mounting cavity and electrically connected to the circuit board; an eccentric block rotationally coupled to a rotating shaft of the drive motor; a fixed cover disposed on the drive motor and fixedly connected to the mounting plate, which fixedly disposes the drive motor in the second mounting cavity.

In one embodiment, the wireless charging assembly comprises a wireless charging receiving coil, the wireless charging receiving coil is fixed in the first mounting cavity and electrically connected to the circuit board.

In one embodiment, the battery assembly is a polymer lithium-ion battery.

In one embodiment, a wireless communication module disposed on the circuit board, configured to establish a wireless connection with an electronic device.

In one embodiment, the wireless communication module is selected from the group consisting of: a Bluetooth wireless communication module, a Wi-Fi wireless communication module, a 4G wireless communication module, a 5G wireless communication module, and combinations thereof.

In one embodiment, further comprising a button assembly disposed on the circuit board, wherein the button assembly extends through the housing assembly.

In one embodiment, the button assembly comprises a button body, which is arranged on the circuit board; and a button housing arranged on the button body and penetrating the housing assembly.

In one embodiment, the button housing is made of silicone.

In one embodiment, the housing assembly is detachably provided with an elastic outer housing.

After adopting the above technical solutions, the adult massager provided by the present disclosure has beneficial effects as follows:

The vibration mechanism of an adult toy in the present invention is designed through the vibration assembly to have different vibration modes and intensity levels, so that users can choose a vibration experience suitable for themselves according to their personal preferences, thereby enhancing the applicability and personalization of the product, thus stimulating the body's sensitive nerves; by integrating an LED light assembly, it increases the visual feedback effect, enriches the user experience, and makes the product more attractive; by reasonably designing the sealing structure of the upper housing and the lower housing, the waterproof level of the product is improved and the scope of use is expanded; by using the wireless charging assembly to charge the battery wirelessly, the endurance of the vibration mechanism is significantly improved, the need for frequent charging by users is reduced, and the waterproof performance of the vibration mechanism is improved to a certain extent.

The vibration mechanism of an adult toy of the present invention, wherein the vibration assembly, the LED light assembly, the battery assembly and the circuit board are respectively fixed on the mounting plate, and wherein the mounting plate is detachably secured within the housing assembly, thereby providing improved assembly efficiency of the product.

### BRIEF DESCRIPTION OF DRAWINGS

In order to more clearly illustrate technical solutions in embodiments of the present disclosure, drawings required in description or prior art are briefly introduced below, and obviously, the drawings in the following description are merely some embodiments of the present disclosure. For a person having ordinary skill in art, other drawings may be obtained according to the drawings without creative efforts.

FIG. 1 is a perspective view illustrating a vibration mechanism for an adult toy in accordance with the present invention.

FIG. 2 is a schematic view of the vibration mechanism of FIG. 1 from an alternative perspective.

FIG. 3 is a cross-sectional view of the vibration mechanism of FIG. 1.

FIG. 4 is an exploded assembly view of the vibration mechanism of FIG. 1, depicting a main housing and a mounting plate.

FIG. 5 is a cross-sectional view of the main housing illustrated in FIG. 4.

FIG. 6 is a detailed schematic view of the mounting plate shown in FIG. 4.

### REFERENCE NUMBER IN THE DRAWINGS

| | | | |
|---|---|---|---|
| housing assembly | 11 | main housing | 111 |
| light-transmissive housing | 1111 | mounting groove | 1112 |
| first installation cavity | 1113 | first anti-slip patterns | 1114 |
| first limiting hole | 1115 | through hole | 1116 |
| second mounting cavity | 112 | second anti-slip patterns | 1121 |
| second limiting hole | 1122 | mounting plate | 12 |
| second mounting cavity | 121 | third mounting cavity | 122 |
| limiting groove | 123 | clamping edge | 124 |
| vibration assembly | 13 | drive motor | 131 |
| eccentric block | 132 | fixed cover | 133 |
| LED light assembly | 14 | light board | 141 |
| LED light | 142 | wireless charging assembly | 15 |
| battery assembly | 16 | circuit board | 17 |
| button assembly | 18 | button body | 181 |
| button housing | 182 | | |

### DETAILED DESCRIPTION

The following describes in detail the embodiments of the present disclosure, examples of which are illustrated in the accompanying drawings, wherein the same or similar reference numerals refer to the same or similar elements or elements having the same or similar functions throughout. The embodiments described below with reference to the accompanying drawings are exemplary, and are not intended to limit the present disclosure.

In order to make the purpose, technical solutions, and advantages of the present disclosure clear, the following further describes the present disclosure in detail with reference to accompanying drawings and embodiments.

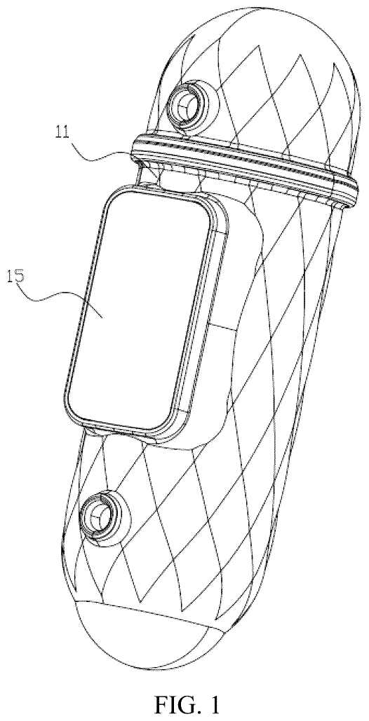

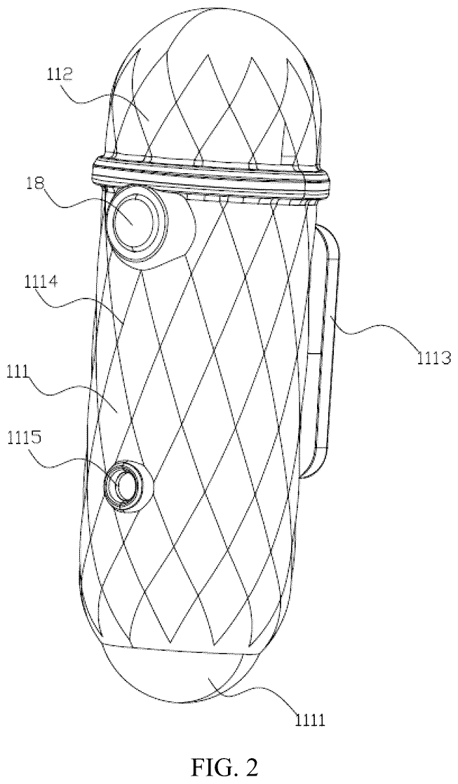

Referring to FIG. 1 to FIG. 4, the present disclosure provides a housing assembly 11, a mounting plate 12, a vibration assembly 13, an LED light assembly 14, a wireless charging assembly 15, a battery assembly 16, a circuit board 17, a button assembly 18; the housing assembly 11 is a hollow cavity; the mounting plate 12 detachably engaged into the housing assembly 11; the vibration assembly 13, the LED light assembly 14, the battery assembly 16, and the circuit board 17 are respectively fixedly mounted on the mounting plate 12; the vibration assembly 13 sequentially drives the mounting plate 12 and the housing assembly 11 to perform a vibration operation; the LED light assembly 14 is configured to emit light in different colors, and the light emitted from the LED light assembly is transmissible through the housing assembly 11; the battery assembly 16 provides power to the vibration assembly 13, the LED light assembly 14 and the circuit board 17; the circuit board 17 being electrically connected to the vibration assembly 13, the LED light assembly 14, the wireless charging assembly 15, the battery assembly 16 and the button assembly 18; the wireless charging assembly 15 is fixed on the housing assembly 11, and the battery assembly 16 is charged by the wireless charging assembly 15; the button assembly 18 is disposed on the circuit board 17 and penetrates the housing assembly 11, and the switch and function setting of the vibration mechanism are realized through the button assembly 18. In other embodiments, the wireless charging assembly 15 may also be fixed in the housing assembly 11, and the battery assembly 16 is charged via the wireless charging assembly 15.

Referring to FIG. 1 to FIG. 4, in the embodiment, the housing assembly 11 comprises a main housing 111 forming a hollow body with an open end; and an upper housing 112 fixedly secured to the open end of the main housing 111 to form an enclosed hollow cavity, wherein the mounting plate 12 is detachably engaged within the enclosed hollow cavity. Specifically, a sealing ring is installed at the joint between the main housing 111 and the upper housing 112, and the sealing ring is used to enhance the waterproof performance of the connection portion between the main housing 111 and the upper housing 112.

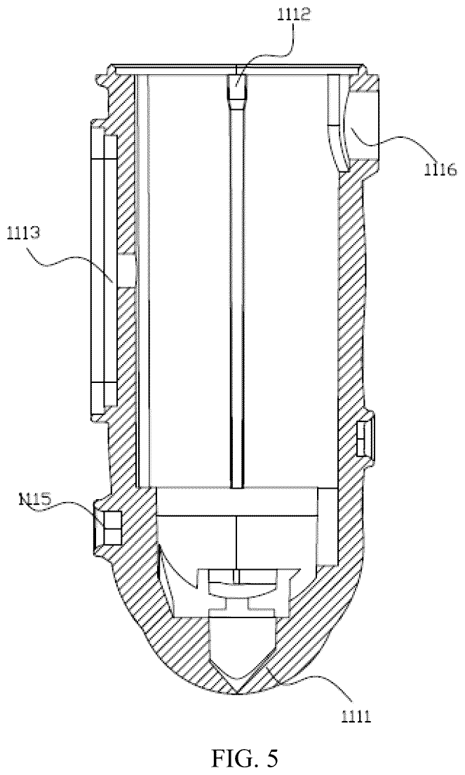

Referring to FIG. 1 to FIG. 5, specifically, a light-transmissive housing 1111 is disposed on the main housing 111 opposite to the open end, and the light emitted by the LED light assembly 14 is transmitted out of the main housing 111 through the light-transmissive housing 1111; mounting grooves 1112 are symmetrically provided on the inner wall of the main housing 111; two ends of the mounting plate 12 are respectively detachably engaged in the two mounting grooves 1112, so as to realize the detachable engagement connection between the mounting plate 12 and the main housing 111; a first mounting cavity 1113 is provided on the main housing 111, and the wireless charging assembly 15 is fixed in the first mounting cavity 1113 and electrically connected to the circuit board 17. A plurality of first anti-slip patterns 1114 are provided on the outer side of the main housing 111, and the plurality of first anti-slip patterns 1114 increase the friction between the elastic housing and the main housing 111, thereby improving the fit between the elastic housing and the main housing 111; at least one first limiting hole 1115 and through hole 1116 are provided on each of the main housing 111, and an elastic outer housing is limit-installed on the main housing 111 through the first limiting holes 1115, the button assembly 18 passes through the main housing 111 through the through hole 1116. Specifically, a plurality of second anti-slip patterns 1121 are provided on the outer side of the upper housing 112, and the plurality of second anti-slip patterns 1121 increase the friction between the elastic housing and the upper housing 112, thereby improving the fit between the elastic housing and the upper housing 112; at least one second limiting hole 1122 and through hole 1116 are provided on both the upper housing 112, and the elastic outer housing is limit-installed on the upper housing 112 through the second limiting holes 1122.

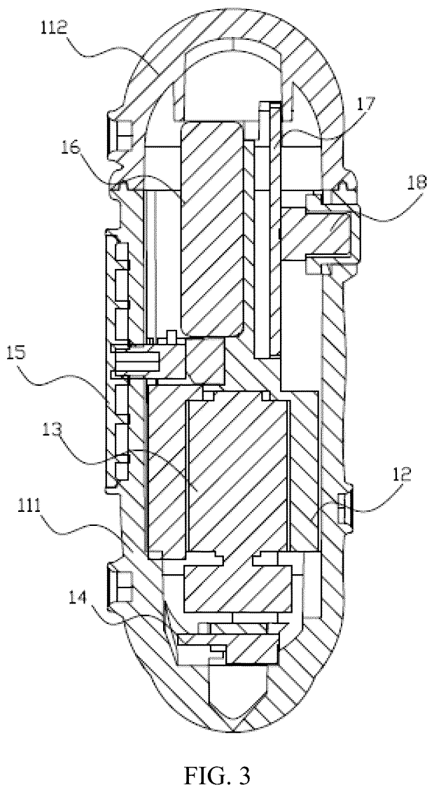

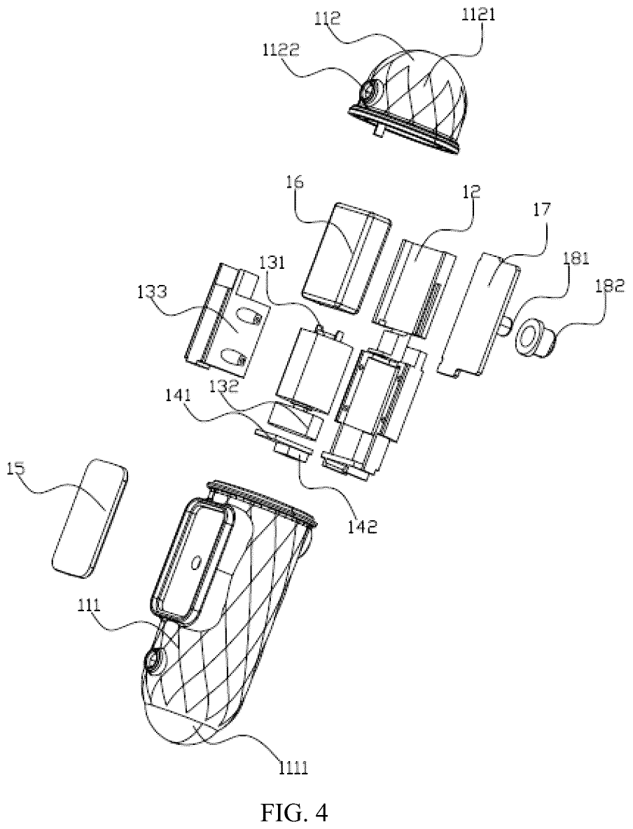

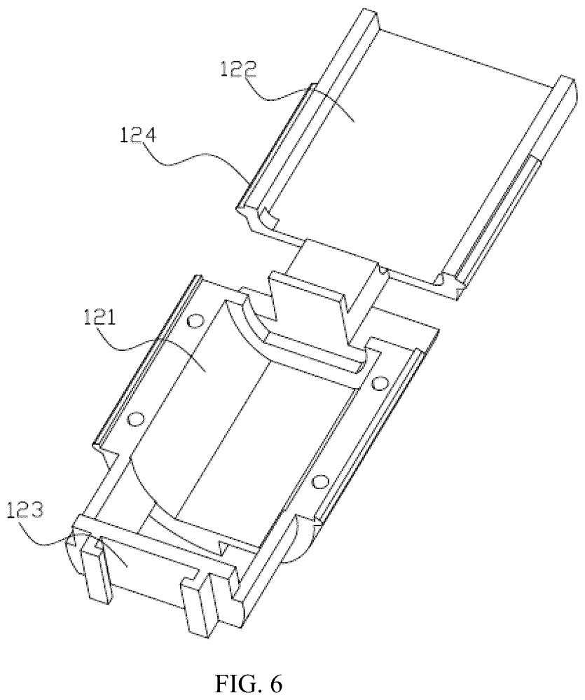

Referring to FIG. 3, FIG. 4 and FIG. 6, in this embodiment, the mounting plate 12 is provided with a second mounting cavity 121, a third mounting cavity 122 and a limiting groove 123, the vibration assembly 13, the battery assembly 16, and the LED light assembly 14 are fixedly arranged on the second mounting cavity 121, the third mounting cavity 122, and the limiting groove 123 respectively; clamping edges 124 are respectively provided on both sides of the mounting plate 12, and the two clamping edges 124 are respectively detachably snapped into the corresponding mounting grooves 1112, thereby realizing a detachable engaging connection between the mounting plate 12 and the main housing 111.

Referring to FIG. 3 and FIG. 4, in this embodiment, the vibration assembly 13 comprises a drive motor 131, an eccentric block 132 and a fixed cover 133; the drive motor 131 is disposed in the second mounting cavity 121 and is electrically connected to the circuit board 17; the eccentric block 132 is transmission-connected to the rotating shaft of the drive motor 131, and the drive motor 131 drives the eccentric block 132 to rotate, thereby realizing the vibration function; the fixed cover 133 is disposed on the drive motor 131 and fixedly connected to the mounting plate 12, and fixes the drive motor 131 in the second mounting cavity 121. Specifically, the LED light assembly 14 includes a light board 141 and an LED light 142. The light board 141 is fixed in the limiting groove 123 and is electrically connected to the circuit board 17. The LED light 142 is fixed on the light board 141 and can emit lights of different colors. The light emitted by the LED light 142 is transmitted out of the housing assembly 11 through the light-transmissive housing 1111, thereby enabling corresponding light interactive feedback operations. Specifically, the wireless charging assembly 15 comprises a wireless charging receiving coil, the battery assembly 16 is charged by the wireless charging receiving coil cooperating with an external wireless charging transmitting coil. The wireless charging receiving coil is fixedly arranged in the first installation cavity 1113 and electrically connected to the circuit board 17. The battery assembly 16 is a polymer lithium-ion battery.

Referring to FIG. 3 and FIG. 4, in this embodiment, the circuit board 17 is electrically connected to the vibration assembly 13, the LED light assembly 14, the wireless charging assembly 15, the battery assembly 16, and the button assembly 18 respectively. The control technologies adopted are all existing technologies, so the specific control process and the models adopted are not described here, as long as they meet the requirements of this application. In this embodiment, a wireless communication module is provided on the circuit board 17, through which the wireless communication module can be wirelessly connected to the electronic devices, so that the vibration mechanism can be wirelessly controlled through an application or applet on the electronic devices. Specifically, the wireless communication module is selected from the group consisting of: a Bluetooth wireless communication module, a Wi-Fi wireless communication module, a 4G wireless communication module, a 5G wireless communication module, and combinations thereof. Preferably, the wireless communication module is a Bluetooth wireless communication module. In this embodiment, the button assembly 18 comprises a button body 181 and a button housing 182. The button body 181 is disposed on the circuit board 17. The switch and function setting of the vibration mechanism can be realized through the button body 181; the button housing 182 is disposed on the button body 181 and penetrates the housing assembly 11 through the through hole 1116; specifically, the button housing 182 is made of a flexible material, which can seal the contact portion with the inner wall of the through hole 1116, thereby improving the waterproof performance of the vibration mechanism. Preferably, the button housing 182 is made of silicone.

It should be noted that the specific working process of the vibration mechanism of an adult toy of the present invention is as follows: the vibration mechanism of the present invention as an adult toy is covered with a silicone shell on the outside, and the design of the anti-slip pattern and the limiting hole makes the silicone shell and the vibration mechanism more tightly connected. When the user starts the vibration mechanism through the button assembly 18, the circuit board 17 sends a start command to the drive motor 131, and the drive motor 131 starts to rotate, driving the eccentric block 132 arranged on its rotating shaft to rotate, thereby generating a vibration effect. The rotational unbalanced force of the eccentric block 132 generates periodic vibrations, which are sequentially transmitted to the mounting plate 12 and the housing assembly 11, thereby realizing the vibration operation of the vibration mechanism; the user can select different vibration modes and intensities through the button assembly 18, and the circuit board 17 adjusts the speed of the drive motor 131 according to the user's selection to achieve different vibration intensities; at the same time, the circuit board 17 also controls the color change of the LED light assembly 14 to match different vibration modes and provide visual feedback; at the same time, the battery assembly 16 supplies power to the vibration assembly 13, the LED light assembly 14, and the circuit board 17 respectively. The battery assembly 16 can be charged through the wireless charging assembly 15. When the battery assembly 16 is low on power, the user can charge the battery assembly 16 through the wireless charging assembly 15 to ensure the continuous operation of the vibration mechanism.

The technical features of the above-described embodiments may be arbitrarily combined. To make the description concise, not all possible combinations of the technical features in the embodiments are described. However, as long as there is no contradiction in the combination of these technical features, they should be considered to be within the scope of this specification.

Above are only preferred embodiments of the present disclosure and are not intended to limit the present disclosure. Any modification, equivalent replacement and improvement made within spirit and principle of the present disclosure should be included in protective scope of the present disclosure.

What is claimed is:

1. A vibration mechanism for an adult toy, comprising:
a housing assembly;
a mounting plate detachably engaged into the housing assembly;
a vibration assembly fixed on the mounting plate, wherein the vibration assembly sequentially drives the mounting plate and the housing assembly to perform a vibration operation;
an LED light assembly fixed on the mounting plate, wherein the LED light assembly is configured to emit light in different colors, and the light emitted from the LED light assembly is transmissible through the housing assembly;
a battery assembly fixed on the mounting plate;
a wireless charging assembly integrated within or on the housing assembly, configured to wirelessly recharge the battery assembly; and
a circuit board fixed on the mounting plate, the circuit board being electrically connected to the vibration assembly, the LED light assembly, the wireless charging assembly and the battery assembly respectively.

2. The vibrating mechanism of an adult toy according to claim 1, wherein the housing assembly comprises a main housing forming a hollow body with an open end; an upper housing fixedly disposed at the open end of the main housing, wherein the upper housing and the main housing are hermetically connected to form an enclosed hollow cavity; and the mounting plate is detachably engaged within the enclosed hollow cavity.

3. The vibrating mechanism of an adult toy according to claim 2, wherein a light-transmissive housing is disposed on the main housing opposite to the open end, and the light emitted by the LED light assembly is transmitted out of the main housing through the light-transmissive housing.

4. The vibrating mechanism of an adult toy according to claim 3, wherein the LED light assembly comprises a light board fixed in the positioning groove of the mounting plate and electrically connected to the circuit board; and an LED light fixed on the light board can emit lights of different colors, and the light emitted by the LED light is transmitted out of the housing assembly through the light-transmitting housing.

5. The vibrating mechanism of an adult toy according to claim 2, wherein mounting grooves are symmetrically provided on the inner wall of the main housing; clamping edges are respectively provided on both sides of the mounting plate, and the two clamping edges are respectively detachably snapped into the corresponding mounting grooves.

6. The vibrating mechanism of an adult toy according to claim 2, wherein a first mounting cavity is provided on the main housing, and the wireless charging assembly is fixed in the first mounting cavity and electrically connected to the circuit board.

7. The vibrating mechanism of an adult toy according to claim 2, wherein a plurality of anti-slip patterns are provided on the outer sides of both the main housing and the upper housing.

8. The vibrating mechanism of an adult toy according to claim 2, wherein at least one limiting hole is provided on each of the main housing and the upper housing, and an elastic outer housing is installed on the housing assembly through the limiting holes.

9. The vibrating mechanism of an adult toy according to claim 6, wherein a second mounting cavity and a third mounting cavity are respectively provided on the mounting plate; the vibration assembly and the battery assembly are respectively fixed within the second mounting cavity and the third mounting cavity.

10. The vibrating mechanism of an adult toy according to claim 9, wherein the vibration assembly comprises a drive motor disposed in the second mounting cavity and electrically connected to the circuit board; an eccentric block rotationally coupled to a rotating shaft of the drive motor; a fixed cover disposed on the drive motor and fixedly connected to the mounting plate, which fixedly disposes the drive motor in the second mounting cavity.

11. The vibrating mechanism of an adult toy according to claim 9, wherein the wireless charging assembly comprises a wireless charging receiving coil, the wireless charging receiving coil is fixed in the first mounting cavity and electrically connected to the circuit board.

12. The vibration mechanism of an adult toy according to claim 9, wherein the battery assembly is a polymer lithium-ion battery.

13. The vibration mechanism of an adult toy according to claim 1, wherein a wireless communication module disposed on the circuit board, configured to establish a wireless connection with an electronic device.

14. The vibration mechanism of an adult toy according to claim 13, wherein the wireless communication module is selected from the group consisting of: a Bluetooth wireless communication module, a Wi-Fi wireless communication module, a 4G wireless communication module, a 5G wireless communication module, and combinations thereof.

15. The vibration mechanism of an adult toy according to claim 13, further comprising a button assembly disposed on the circuit board, wherein the button assembly extends through the housing assembly.

16. The vibration mechanism of an adult toy according to claim 15, wherein the button assembly comprises a button body, which is arranged on the circuit board; and a button housing arranged on the button body and penetrating the housing assembly.

17. The vibration mechanism of an adult toy according to claim 16, wherein the button housing is made of silicone.

18. The vibration mechanism of an adult toy according to claim 1, wherein the housing assembly is detachably provided with an elastic outer housing.
